(19) United States
(12) Patent Application Publication
(10) Pub. No.: US 2021/0017777 A1
(43) Pub. Date: Jan. 21, 2021

(54) ROOFING GUARD FOR CARPENTERS

(71) Applicants: Rino P. Albert, Scarborough (CA); Matthew Albert, Scarborough (CA)

(72) Inventors: Rino P. Albert, Scarborough (CA); Matthew Albert, Scarborough (CA)

(21) Appl. No.: 16/516,446

(22) Filed: Jul. 19, 2019

(51) Int. Cl. E04G 21/32; E04G 5/04

(52) U.S. Cl. CPC E04G 21/3214; A62B 35/0006; E04G 21/3276; E04G 5/041

(57) ABSTRACT

In various aspects and embodiments a roofing guard device 200 comprises a mount portion 210, brace portion 220, optional lateral supports 240, and restraint flanges 214, 216, as well as optional fall-arrest mount(s) 230. By securely supporting a foot guard 12 such as a board or plank and providing secure attachment points for roofing harnesses 400 or other fall-arrest devices, the roofing guard device 200 provides increased protection against falls and other mishaps. When configured such that a gap between the foot guard 12 and an edge 101 of the roof 100 is entirely or substantially eliminated, roofing guard devices in accordance with the invention can further help to eliminate dangers from falling tools, hardware, etc.

### FIELD OF THE INVENTION

The invention relates to devices for improved roofing safety, and particularly to improved devices used for installing, maintaining, and repairing sloped roofs.

### BACKGROUND

Roofing has long been known to be a dangerous occupation. Slips, falls, injuries and deaths are too common. A number of solutions have previously been proposed, yet problems persist, with respect to both safety and the contributions of the solutions to efficiency in getting the job done,

For example, the bracket shown in FIGS. 1 and 2, though it represented a substantial improvement over previous devices, suffers from at least three significant problems: (1) the security of the foot guard 12 when supported by the brackets 900; (2) the creation of a gap 910 between the edge 101 of the roofing surface 100 and the lower edge 14 of the side 16 of the foot guard 12 adjacent the worker's foot 92 when the bracket is installed; and (3) lack of any means for the worker 90 to secure a personnel safety device, such as a restraining harness, to the bracket 900.

As a result of these shortcomings, the foot guard 12 is likely to slip upward along the support portion 912 of the bracket 900, in the direction of the arrows 905, even if the worker 90 is constantly vigilant to avoid shifting it, potentially causing both the foot guard 12 and the worker 90 to fall from the roof, creating a hazard not only for the falling worker and any tools he/she may be working with, but for anything that might be below—including passersby.

Moreover, the presence of the gap 910 means that if the worker drops any hammers or other tools or hardware, they are likely to slide along the roof to the gap 910, fall between the roof 100 and the foot guard 12, and endanger anything and anyone below.

And the absence of any means for securing himself to the roofing bracket, via a personnel restraint device, means that the worker 90 is in constant danger of falling from the roof to whatever happens to be below.

In its various aspects, the invention disclosed herein addresses these problems, and offers further advantages.

### SUMMARY OF THE INVENTION

In various aspects and embodiments the invention provides improved roofing safety devices. In particular, the invention provides improved roofing guard devices configured for permanent or releasable attachment to roofing surfaces, in order to provide permanent or removable support, with greater reliability, for foot guards such as 2″×4″, 2″×6″, or other boards in such manner as to help prevent carpenters, shinglers, and other roofing workers from falling from rooftops.

For example, in one aspect the invention provides a roofing guard device, such as a bracket, comprising at least a mount portion, a foot-guard brace portion, and a fall-arrest safety mount. The mount portion can be adapted for permanent or releasable and in all cases secure, attachment, e.g., by means of nails or screws, to a roofing surface, such as a plywood or other wooden substrate, for example. The foot-guard brace portion can be adapted to permanently or releasably support a foot guard in a generally orthogonal relationship with respect to the roofing surface. For secure support of the foot guard, the foot-guard brace can include a retainer flange adapted to firmly restrain the foot guard from moving away from the foot-guard brace or the roof, in order to ensure that a worker on the roof might is not deprived of needed support.

Fall-arrest safety mounts in accordance with such embodiments can be adapted for permanent or releasable attachment of one or more personnel fall arrest devices, such as safety straps or safety lines, and can be provided on either or both of the mount portion and the foot-guard brace portion. As described below, a very wide variety of fall-arrest safety mounts can be provided, for cooperation with a very wide variety of personnel safety devices, such as restraining straps.

In various embodiments, roofing guard devices in accordance with the invention can include one or more lateral braces configured to extend away from sides of the mounting portion, in order to provide greater stability to the roofing guard device, and therefore increased roofer safety. In such embodiments, the mount portion and the foot-guard brace portion can be integrally formed of flat sheet or bar stock.

Among the additional improvements offered by various aspects and embodiments of the invention is placement of lateral brace(s) as described above, one on either side of the mounting portion, at such a distance from the foot-guard brace portion that when the roofing guard device is installed on a roofing surface with lower edge(s) of the lateral brace(s) aligned with a lower edge of the roofing surface, there is substantially no gap between the lower edge of the roofing surface and an edge of an installed foot guard.

These and further aspects, advantages, and embodiments of the invention are disclosed below, with reference to the attached Figures.

### BRIEF DESCRIPTION OF THE DRAWINGS

Various aspects and embodiments of the invention are illustrated in the accompanying drawings, which are meant to be exemplary and not limiting, and in which like references are intended to refer to like or corresponding parts.

FIGS. 1 and 2 are schematic perspective views of a prior art roofing bracket installation, illustrating some of the shortcomings of the prior art.

FIGS. 3A and 3B are schematic perspective diagrams of roofing guards in accordance with various aspects and embodiments of the invention.

FIG. 4 is a schematic side view of an embodiment of a roofing guard installation in accordance with aspects and embodiments of the invention.

### DESCRIPTION OF EMBODIMENTS

Preferred embodiments of the various aspects of the invention are described through reference to the drawings.

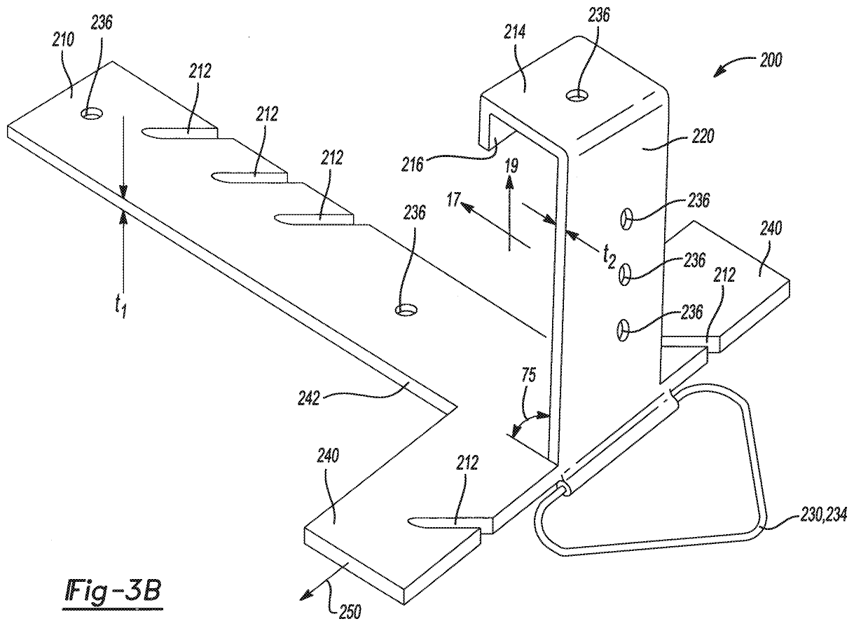

FIGS. 3A and 3B are schematic perspective diagrams of embodiments of roofing guard devices 200 in accordance with various aspects of the invention. In the embodiments shown, roofing guard devices 200 comprise mount portions 210, foot-guard brace portions 220, and fall-arrest safety mounts 230.

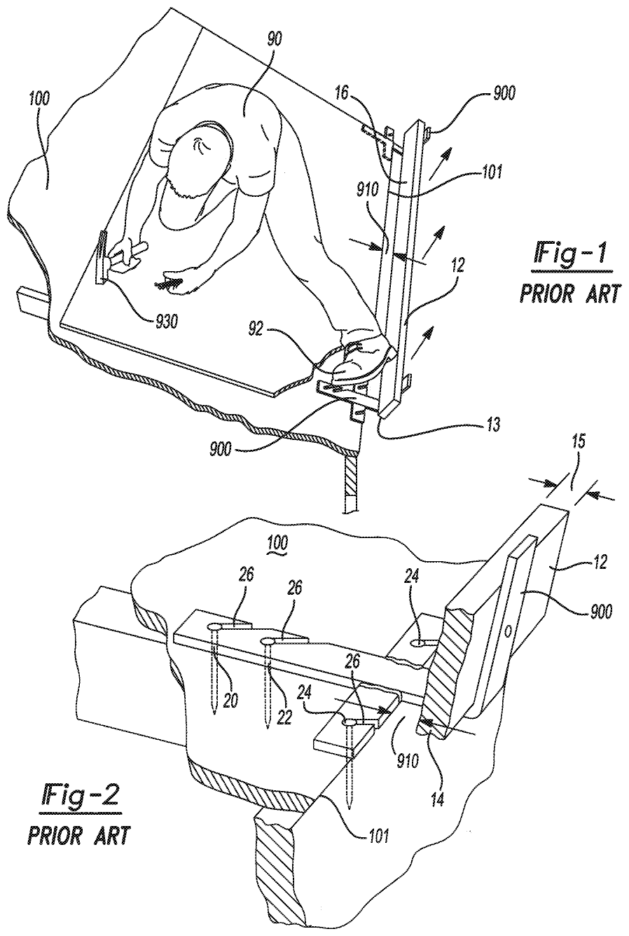

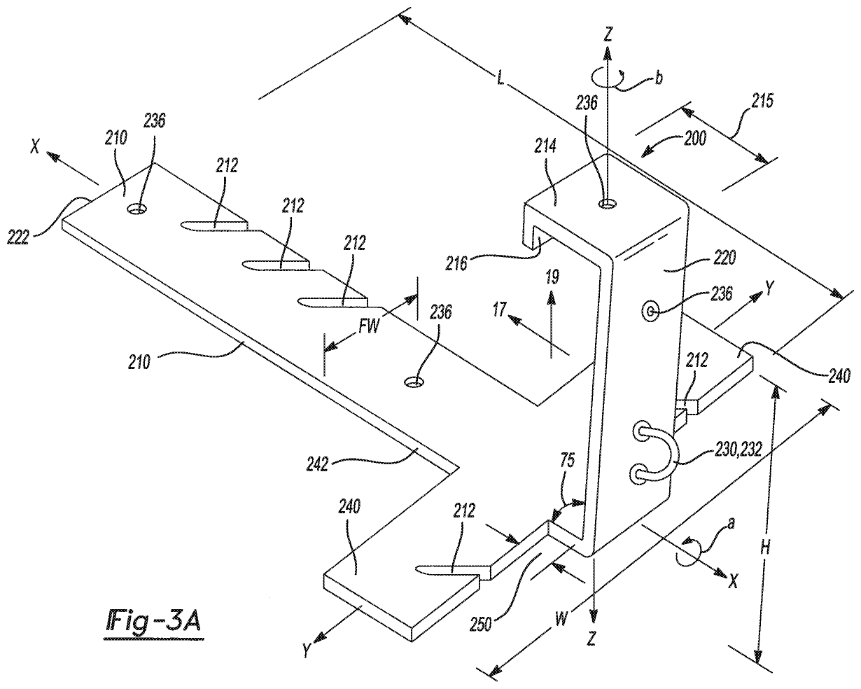

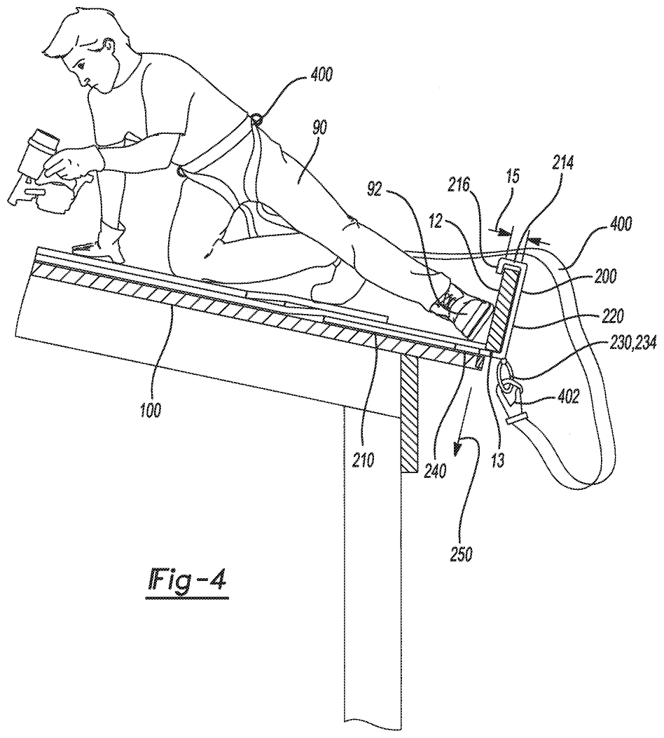

Mount portions 210 of FIGS. 3A and 38 are, in the embodiments shown, adapted for secure attachment, either permanently or releasably, to a roofing surface 100, as shown for example in FIG. 1, by means of slots 212, which are adapted to releasably or permanently receive nails, screws, or other fasteners 20 (FIG. 2) driven into the roofing surface 100. By for example, by not torqueing such nails or screws to the absolute tightness into the roofing surface 100, the rack can be removed by tapping the foot-guard brace portion 220 or any other part of the device 200 with a hammer or other tool 930 (FIG. 1), and thereafter slipping and/or pulling the device 200 from beneath any tar paper, shingles, and/or other coverings that may have been laid atop it (see for example FIG. 4), by causing the device 200 to slide along the fasteners 20 by means of slots 212. Alternatively, if a roofing guard device 200 is to remain in place indefinitely, the screws or nails 20 can be torqued down more firmly, and/or slots 216 may be replaced with holes 236.

In the embodiments shown in FIGS. 3A and 3B, foot-guard brace portions 220 of devices 200 are adapted to permanently or releasably support a foot guard 12 such as a board in a generally or substantially orthogonal relationship with respect to the roofing surface by virtue of their having been configured at approximately a 90-degree angle 15 from the corresponding mount portions 210, by bending or other means. In addition, in the embodiments shown, foot-guard brace portions 220 comprise retainer flanges 214, 216 adapted to restrain the foot guard 12 from lateral movement in directions 17, 19 respectively parallel to and/or orthogonal from the roofing surface 100 while the foot guard 12 is supported by the foot-guard brace portion 220. In the embodiments shown, for example, flange portions 214 are adapted to restrain the foot guards 12 from movement in direction 19, orthogonal to the roofing surface 100; and from movement parallel to the roofing surface 100 in direction 17 by the configuration of flange portions 216. As will be readily understood by those skilled in the relevant arts, foot guards 12 can be restrained from lateral movement in directions opposite to directions 17, 19, by the presence of brace portions 220 and mount portions 210, respectively.

Alternatively, or in addition, foot guards 12 can be restrained from movement in directions 17, 19, etc., by driving nails, screws, or other fasteners into the guards 12 through some or all of holes 236.

In the embodiments shown in FIGS. 3A, 3B, and 4, roofing guards 200 further include a variety of fall-arrest safety mounts 230, which are adapted for different methods of permanently or releasably attaching one or more personnel restraint devices 400, such as a full or partial body harness. In the example shown in FIG. 3B, fall-arrest safety mount 230, include lug 232, which can for example be used to clip or otherwise attach harnesses or other devices 400 of a user 90 to the roofing guard device, as shown for example in FIG. 4. Such safety mounts can provide secure support for a user 90, and/or various tools, etc., by virtue of the fact that mount portion 210 of the guard device 200 is securely attached to the roofing surface 100.

In the embodiments shown in FIGS. 3A and 3B, roofing guard devices 200 can further comprise lateral brace portions 240, which are adapted, when the roofing guard device 200 is attached to a roofing structure 100, to stabilize the roofing guard from movement in lateral directions Y and/or from rotating in directions a, b, about either of axes X, Z as shown in FIG. 3A. In the embodiments shown, a pair of lateral brace portions 240 are provided, in such manner that they extend from the sides 242 of the mount portion 210, proximate the foot-guard brace portion 220 (i.e, closer to the portion 220 than to distal end 222 of the mount portion 210), in a substantially collinear configuration along axis Y-Y.

As noted above, among the improvements provided by the invention is configuration of roofing guard devices 200 in such fashion that gaps between foot guard(s) 12 and roofing surfaces 100 are minimized or eliminated, such that objects dropped on the roofing surfaces are not able to slide or roll along the roofing surface and drop between the foot guard(s) 12 and the roof 100 and fall onto people and other objects below.

This feature can, for example, be implemented by configuring a distance 250 between the lateral braces 240 and the foot-guard brace potion 220 such that, when the roofing guard 200 is attached to the roof surface 100 with a lower edge of the substantially collinear later braces 240 substantially aligned with a lower edge 101 of the roofing surface and a foot guard 12 is supported by the foot-guard brace portion, there is substantially no gap between the lower edge of the roofing surface and a lower edge or side 13 (FIGS. 1, 4) of the foot guard 12.

This can be accomplished, for example, by configuring the roofing guard device 200 so that the length or dimension 250 is less than or approximately equal to the width 15 of the foot guard 12 (FIGS. 2, 4) intended for use with the guard device 200. Alternatively, or in addition, the length or dimension 250 can be less than or approximately equal to a length 225 of retention flange 214 (FIG. 3A).

As will be appreciated by those skilled in the relevant arts, the thickness(s) or gauges “t” (FIG. 3B) and other dimensions of roofing guard devices 200, and/or the various components or portions 210, 220, 214, 216, etc., can be determined by a number of factors, including the applications to which they are to be put, and the loads expected to be supported by them, including the expected number(s) and weight(s) of roofer(s) 90 to be protected by the devices 200, the nature of the tools the roofers are expected to use, the height of the roof 100 from the ground, etc. Selection of suitable dimensions and materials will not trouble those of ordinary skill in the art, once they have been made familiar with this disclosure.

For example, in some currently preferred embodiments roofing devices in accordance with the invention are formed from flat steel sheet of thickness or gauge t of approximately ⅛^{th} inch, with lengths L and W of approximately 12 inches and 6 inches respectively, heights H of approximately 5 inches, and uniform or varied flange widths FW of between 1 and 2 inches (FIG. 3A). Such steel can be of flat sheet or bar stock. Lateral support portions 240, foot-guard brace portions 220, etc., can be integrally formed by suitable trimming and/or bending processes, and/or can be welded or otherwise attached to mount portions 210, etc.

As previously noted, fall-arrest safety mounts 230 can be provided in a very wide variety of configurations, depending upon the desired types of fall-arrest harnesses or systems 400 (FIG. 4) to be used with the devices 200. For example, any varieties of rings 234, lugs 232, and/or other devices can be permanently affixed by welding, integral formation, etc.; and/or they can be removably attached by means of bolts, etc., secured through threaded or unthreaded holes 236. Such devices can be configured to interact with any desired hooks, rings, or other devices 402 of harnesses or other fall-arrest devices or systems 400.

In some presently-preferred embodiments, fall-arrest safety mounts 230 are provided in the form of swiveled rings 234 provided in swivels 235 welded or otherwise permanently attached to any or all of foot-guard brace portion(s) 220, mount portions 210, and/or lateral support portion(s) 240, as shown for example in FIG. 3B.

FIG. 4 is a schematic side view of an embodiment of a roofing guard installation in accordance with aspects and embodiments of the invention. FIG. 4 shows an embodiment in which a roofer 90 is at work on a roof 100, with his/her foot 92 braced against a foot guard 12 in the form of a 2×6 wooden plank cradled in brace-support portion 220 by means of flanges 214, 216 in such fashion that the flanges prevent the plank from coming away from the brace portion 220, as described above. For added safety, the roofer 90 is wearing a fall-arrest harness 400, which is attached by a double latch hook mechanism 402 to fall-arrest mount 230, in the form of a D-ring swivel-mounted to the base of the roofing guard device 200, at the junction of mount portion 210 and brace portion 220.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

What is claimed is:

1. A roofing guard device, comprising:
a mount portion adapted for permanent or releasable attachment to a roofing surface;
a foot-guard brace portion adapted to permanently or releasably support a foot guard in a substantially orthogonal relationship with respect to the roofing surface, the foot-guard brace portion comprising a retainer flange adapted to restrain the foot guard from lateral movement parallel to and orthogonal from the roofing surface while the foot brace is supported by the foot-guard brace portion; and
a fall-arrest safety mount adapted for permanent or releasable attachment of a personnel restraint device.

2. The roofing guard device of claim 1, wherein the fall-arrest safety mount is integrally or releasably provided on the foot-guard brace portion.

3. The roofing guard device of claim 1, wherein at least the mount portion and the foot-guard brace portion are integrally formed of flat sheet stock.

4. The roofing guard device of claim 1, wherein at least the mount portion and the foot-guard brace portion are integrally formed of flat bar stock.

5. The roofing guard device of claim 1, comprising at least one lateral brace, the at least one lateral brace extending from a side of the mount portion, proximate the foot-guard brace portion.

6. The roofing guard device of claim 1, comprising at least two lateral braces extending from sides of the mount portion, proximate the foot-guard brace portion, in a substantially collinear configuration.

7. The roofing guard device of claim 6, wherein a distance between the at least two lateral braces and the foot-guard brace potion is configured such that, when the roofing guard is attached to the roof surface with a lower edge of the substantially collinear later braces is aligned with a lower edge of the roofing surface and a foot guard is supported by the foot-guard brace portion, there is substantially no gap between the lower edge of the roofing surface and an edge of the foot guard.

8. The roofing guard device of claim 1, wherein the fall-arrest safety mount comprises at least one support ring permanently attached to at least one of the mount portion and the foot-guard brace portion of the roofing guard device.

9. The roofing guard device of claim 1, wherein the fall-arrest safety mount comprises at least one means for removably attaching the personnel restraint device to at least one of the mount portion and the foot-guard brace portion of the roofing guard device.
